(19) United States
(12) Patent Application Publication
(10) Pub. No.: US 2010/0150146 A1
(43) Pub. Date: Jun. 17, 2010

(54) DEVICE, SYSTEM AND METHOD OF COMMUNICATING BETWEEN CIRCUIT SWITCH INTERFACES OVER AN ANALOG MODULATION COMMUNICATION NETWORK

(76) Inventors: Raul Assia, Jerusalem (IL); Lev Razmat, Ma'aleh Adumim (IL); Noam Swery, Jerusalem (IL); Oren Kedem, Modiin (IL); Yehuda Ben-Simon, Jerusalem (IL); Sara Zevin, Jerusalem (IL)

Correspondence Address: Pearl Cohen Zedek Latzer, LLP, 1500 Broadway, 12th Floor, New York, NY, 10036, US

(21) Appl. No.: 12/709,999

(22) Filed: Feb. 22, 2010

Related U.S. Application Data
(63) Continuation of application No. 11/794,734, filed on Jul. 5, 2007, now abandoned.
(60) Provisional application No. 60/643,148, filed on Jan. 13, 2005.

(51) Int. Cl. H04L 12/50; H04L 5/16

(52) U.S. Cl. 370/359; 375/222

(57) ABSTRACT

Some demonstrative embodiments of the invention include a method device and/or system of communicating circuit switch information, e.g., between two or more circuit switch interfaces, over an analog modulation communication network. The method, according to some demonstrative embodiments may include synchronizing at least one slave clock of at least one respective local circuit switch interface to a master clock of a master circuit switch interface which communicates with the at least one local circuit switch interface over an analog modulation communication network. Other embodiments are described and claimed.

### CROSS-REFERENCE TO RELATED APPLICATIONS

This application is a Continuation of U.S. patent application Ser. No. 11/794,734 filed on Jul. 5, 2007 entitled “Device, System and Method of Communicating Between Circuit Switch Interfaces Over an Analog Modulation Communication Network” which claims priority of U.S. provisional Patent Application 60/643,148 filed Jan. 13, 2005, entitled “Method Apparatus and System for Transmission of Digital Circuit Signals”, each of which being incorporated herein by reference in its entirety.

### FIELD OF INVENTION

The present invention generally relates to communication systems and methods and, more particularly, to devices, systems and methods of communicating circuit switch information, e.g., over an analog modulation communication network.

### BACKGROUND OF THE INVENTION

The most common way of transmitting telephone signals is via a Time-Division-Multiplexed (TDM) group of digital circuit signals that is named, for example, E1 or T1. Such a group may be a trunk group or a loop group.

It is sometimes desirable to transmit the digital circuit signals over an analog modulation communication network, e.g., a Cable Television (CATV) transmission media, that uses an Internet Protocol (IP) transmission method, for example, in compliance with standards for packet transmission, e.g., DOCSIS, EURODOCSIS, Wimax, IEEE 802.16, and the like.

In such cases, conventional systems may implement a conversion of the digital circuit signals into a Voice-Over-IP format. This however, may make it difficult to comply with performance requirements relating to the digital circuit signals, which may not be readily available via IP packet transmission. These performance requirements may include, for example, Round-Trip-Delay (RTD), jitter, packet loss and constant bit rate.

Furthermore, the use of IP as the transmission method with its Ethernet packet structure is highly inefficient in the utilization of bandwidth.

### SUMMARY OF SOME DEMONSTRATIVE EMBODIMENTS OF THE INVENTION

Some demonstrative embodiments of the invention include a method device and/or system of communicating circuit switch information, e.g., between two or more circuit switch interfaces, over an analog modulation communication network.

According to some demonstrative embodiments of the invention, a system of communicating over an analog modulation communication network, may include a master circuit switch interface; at least one local circuit switch interface; and an interfacing arrangement to communicate between the master interface and the at least one local interface over the analog to modulation network, and to synchronize at least one slave clock of the at least one local interface to a master clock of the master interface.

According to some demonstrative embodiments of the invention, the interfacing arrangement may include, for example, a station, e.g., a head-end station, connected to the first circuit switch network and to the analog modulation communication network; and at least one modem connected to the at least one local interface, the modem able to communicate with the station over the analog modulation communication network.

According to some demonstrative embodiments of the invention, the station may include a first reconstructor to generate a reconstructed master clock based on one or more circuit switch transmissions received from the master interface; and a transmitter to transmit one or more analog transmissions over the analog modulation network using the reconstructed master clock.

According to some demonstrative embodiments of the invention, the modem may include a receiver to receive the analog transmissions; and a second reconstructor to generate a reconstructed analog transmission clock based on the received transmissions, and set the slave clock based on the reconstructed analog transmission clock.

According to some demonstrative embodiments of the invention, the first reconstructor may convert a circuit-switch frequency of the reconstructed master clock into a frequency suitable for the analog transmissions.

According to some demonstrative embodiments of the invention, the modem may receive from the local interface upstream circuit switch information intended for the master interface; to transmit over the analog modulation network one or more analog modulation frames including the upstream circuit switch information; and to time the transmission of the analog modulation frames including the upstream circuit switch information based on the slave clock.

According to some demonstrative embodiments of the invention, the station may receive from the master interface downstream circuit switch information intended for the local interface; transmit over the analog modulation network one or more analog modulation frames including the downstream circuit switch information; and prioritize the transmission of frames that include the downstream circuit switch information at a higher priority than frames that include downstream information received from another communication network interface. The other communication network may include, for example, an internes protocol data transmission network.

According to some demonstrative embodiments of the invention, the station and/or the modem may include a frame generator to generate an analog modulation frame to be transmitted over the analog modulation network, the frame including an indicator to indicate whether the frame includes circuit switch information received from one of the master and local interfaces.

According to some demonstrative embodiments of the invention, the station and/or the modem may receive the frame from the analog modulation network; and selectively perform an error check of the frame based on a value of the indicator.

According to some demonstrative embodiments of the invention, at least one of the master and local interfaces may include a circuit switch interface selected from the group consisting of an E1 interface, a T1 interface, a J1 interface, an OC3 interface, a STM1 interface, and a DS3 interface.

According to some demonstrative embodiments of the invention, the analog modulation network may include a cable communication network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a communication system according to some demonstrative embodiments of the present invention;

FIG. 2 is a schematic illustration of a head-end station according to some demonstrative embodiments of the invention;

FIG. 3 is a schematic illustration of a communication control module according to some demonstrative embodiments of the invention;

FIG. 4 is a schematic illustration of a downstream communication module according to some demonstrative embodiments of the invention;

FIG. 5 is a schematic illustration of an upstream communication module according to some demonstrative embodiments of the invention;

FIG. 6 is a schematic illustration of a modulator-demodulator (modem) according to some demonstrative embodiments of the invention; and

FIG. 7 is a schematic illustration of an analog modulation frame according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF SOME EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks to (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Part of the discussion herein may relate, for exemplary purposes, to transmitting and/or receiving a packet over a communication network. However, embodiments of the invention are not limited in this regard, and may include, for example, receiving and/or transmitting a signal, a block, a data portion, a data sequence, a frame, a data signal, a preamble, a signal field, a content, an item, a message, a protection flame, or the like.

Not withstanding any conventional meaning of the term “modem” (e.g., modulator-demodulator), in this application, unless specifically stated otherwise, the term “modem” may refer to a modulator, e.g., a device able to modulate data frames of signals to be transmitted and/or to a demodulator, e.g., a device able to demodulate data frames of received signals, and/or to a device able to both modulate and demodulate signals. Implementations of modems in accordance with embodiments of the invention may depend on specific applications and design requirements. Furthermore, modems in accordance with some embodiments of the invention may be implemented by separate modulator and demodulator units or in a single modulator/demodulator unit, and such units may be implemented using any suitable combination of hardware and/or software.

The phrase “analog modulation communication network” as used herein may refer to a communication network, system, infrastructure, configuration, and/or arrangement, which may communicate information modulated over one or more analog signals, e.g., in the form of one or more frames, packets, and the like. The analog modulation network may include, for example, a communication network in accordance with any suitable specification, protocol, and/or standard. For example, the analog modulation network may implement any suitable Internet Protocol (IP) transmission method, e.g., in compliance with the Data Over Cable Service Interface Specification (DOCSIS), the EORODOCSIS, the IEEE 802.16 standard, WiMax, and the like.

Some demonstrative embodiments of the invention include a method, device and/or system of is communicating circuit switch information, e.g., between two or more circuit switch interfaces, over an analog modulation communication network. Some demonstrative embodiments of the invention may include, for example, synchronizing a at least one slave clock of at least one respective local circuit switch interface to a master clock of a master circuit switch interface which communicates with the at least one local circuit switch interface over an analog modulation communication network, e.g., as described in detail below.

Part of the discussion herein may relate, for demonstrative purposes, to communicating between two or more circuit switch interfaces over a cable network, e.g., a Cable Television (CATV) network, for example, using a head end station e.g., a Cable Modem Termination System (CMTS) and/or a modem, e.g., a Cable Modem (CM). However, embodiments of the invention are not limited in this regard, and may include, for example, transmission of circuit switch signals over any other communication network and/or system. For example, some embodiments of the invention may be implemented to communicate between two or more circuit switch interfaces over a wireless communication system, for example, using any suitable station, e.g., a Wireless Base Station (BS), and any suitable modem, e.g., a Wireless Sub Station (SS), e.g., including an IEEE 802.16 Media Access Controller (MAC) as is known in the art.

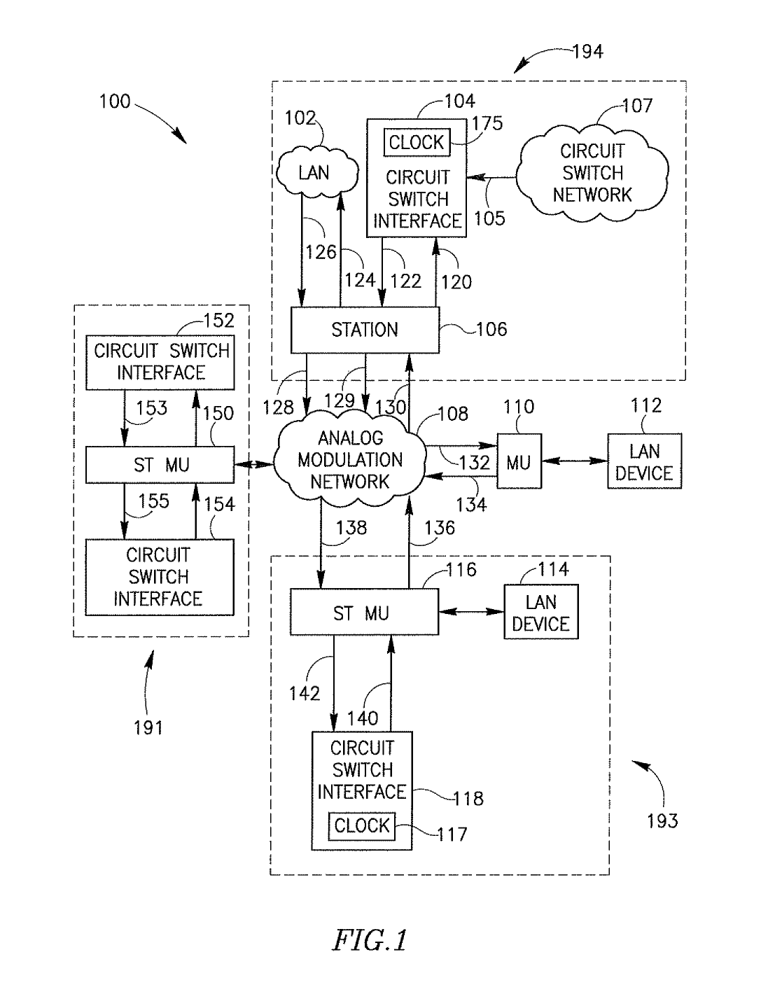

Reference is now made to FIG. 1, which schematically illustrates a communication system 100 in accordance with some demonstrative embodiments of the invention.

According to some demonstrative embodiments of the invention, system 100 may include a Circuit Switch (CS) interface 104 “(the master CS interface”) to communicate with one or more CS interfaces (“the local CS interfaces”), e.g., local CS interfaces 118, 152, and/or 154. CS interfaces 104, 118, 154 and/or 154 may include any suitable circuit switch interface. For example, CS interfaces 104, 118, 154 and/or 154 may include an E1 circuit switch interface, a T1 circuit switch interface, a J1 circuit switch interface, an OC3 circuit switch interface, a STM1 circuit switch interface, or a DS3 circuit switch interface, e.g., as are known in the art.

According to some demonstrative embodiments of the invention, system 100 may include, or may be part of, a point to multi-point communication system, e.g., as is known in the art. For example, master CS interface 104 may be part of a head-end or transmission center, e.g., as are known in the art; and local CS interfaces 118, 152 and/or 154 may be part of one or more local subscriber/user configurations. For example, CS interface 118 may be part of a subscriber configuration 193; and/or CS interfaces 152 and 154 may be part of a subscriber configuration 191.

According to some demonstrative embodiments of the invention, CS interface 104 may generate circuit switch signals, e.g., digital circuit switch signals as are known in the art, including downstream (DS) circuit switch information to be transmitted to one or more of the local CS interfaces. For example, CS interface 104 may generate DS circuit switch signals 122 including DS circuit switch information intended for one or more of CS interfaces 118, 152 and 154.

According to some demonstrative embodiments of the invention, system 100 may also include an interfacing arrangement to communicate between CS interface 104 and one or more of local interfaces 118, 152, and/or 154, over an analog modulation network 108, as described in detail below.

According to some demonstrative embodiments of the invention, analog modulation network 108 may include any suitable network, e.g., a CATV communication network or a wireless communication network, as are known in the art. Although the invention is not limited in this respect, network 108 may operate in accordance with an IP transmission method, e.g., in compliance with the DOCSIS, the EURODOCSIS, the IEEE 802.16 standard, Wimax, or any other suitable cable communication standard, protocol or specification.

According to some demonstrative embodiments of the invention, the interfacing arrangement may include a head-end station 106, e.g., connected to CS interface 104; and one or more Synchronized Transmission (ST) modem units (MUs), e.g., connected to local interfaces 118, 152, and 154. For example, system 100 may include a ST modem 116 connected to local interface 118, and a ST modem 150 connected to ST modem 154, as described in detail below.

Aspects of the invention are described herein in the context of an exemplary communication system, e.g., system 100, wherein a master CS interface, e.g., CS interface 104, and a station, e.g., station 106, are implemented as separate units; and/or wherein a ST modem, e.g., ST modem 116 and ST modem 150, and one or more local CS interfaces, e.g., local CS interfaces 118, 152, and/or 154, are implemented as separate units. It will be appreciated by those skilled in the art that according to other embodiments of the invention, the master CS interface and the station may be implemented as a single module or unit; and/or the ST modem and one or more local CS interfaces connected to the ST modem may be implemented as a single module or unit.

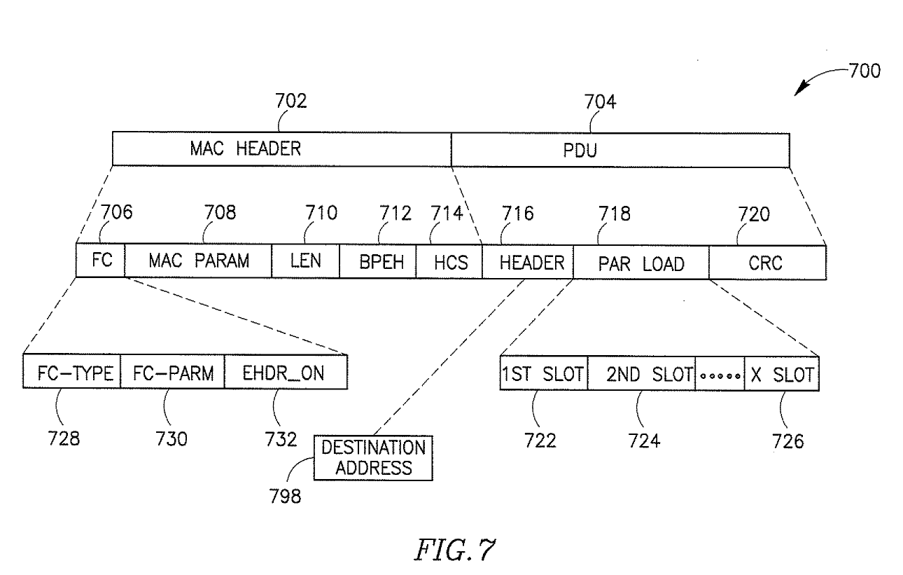

According to some demonstrative embodiments of the invention, station 106 may receive from interface 104 DS signals 122 including CS information, which may be intended for at least one of interfaces 118, 152 and 154 (“the intended interface”). Station 106 may transmit over analog modulation network 108, e.g., to at least one ST modem (“the intended modem”) connected to the intended interface, one or more analog modulation frames 128 including the downstream CS information of signals 122, e.g., as described below. For example, station 106 may address frames 128 to ST modem 116, e.g., if signals 122 include DS circuit switch information intended for CS interface 118; or to ST modem 150, e.g., if signals 122 include DS circuit switch information intended for CS interfaces 152 and/or 154. According to some demonstrative embodiments of the invention, frames 128 may include analog modulation frames in the form of reserved packets, as are defined by the DOCSIS standard, e.g., as described in detail below with reference to FIG. 7.

According to some demonstrative embodiments of the invention, the intended modem, e.g., ST modem 116, may receive from network 108 analog modulation frames, e.g., frames 138, corresponding to frames 128. The intended modem, e.g., ST modem 116, may provide the intended interface, e.g., interface 118, with DS circuit switch signals 142 including the DS information of signals 122, as described below.

According to some demonstrative embodiments of the invention, one or more of the local CS interfaces may generate upstream (US) circuit switch signals including US circuit switch information to be transmitted to CS interface 104. For example, CS interface 118 may generate US circuit switch signals 142; CS interface 152 may generate US circuit switch signals 153; and/or CS interface 154 may generate US circuit switch signals 155.

According to some demonstrative embodiments of the invention, ST modem 116 may receive US signals 140 from interface 118, and may transmit over analog modulation network 108, e.g., to station 106, one or more analog modulation frames 136 including the upstream CS information of signals 140, e.g., as described below. According to some demonstrative embodiments of the invention, station 106 may receive from network 108 analog modulation frames, e.g., frames 130, corresponding to frames 136. Station 106 may provide CS interface 104, with US circuit switch signals 120 including the US information of signals 130, e.g., as described below.

According to some demonstrative embodiments of the invention, station 106 may also to communicate with one or more other communication devices and/or networks, e.g., a Local Area Network (LAN) 102. LAN 102 may include any suitable LAN, for example, an Internet protocol data transmission network, e.g., an IEEE 802.3 Ethernet LAN or any other suitable LAN or wireless LAN (V/LAN), as are known in the art.

According to some demonstrative embodiments of the invention, system 100 may also include is one or more LAN devices able to communicate over analog modulation network 108, e.g., as is known in the art. For example, one or more of the ST modems, e.g., ST modem 116, may also communicate with one or more LAN devices 114. Additionally or alternatively, system 100 may also include one or more modems, e.g., modem unit 110, to connect a LAN device 112 to network 108. MU 110 may include any suitable MU, e.g., as is known in the art. LAN devices 112 and/or 114 may include any suitable communication device able to communicate in accordance with any suitable LAN standard, e.g., as is known in the art. According to some demonstrative embodiments of the invention, system 100 may enable “transparent” connection of standard modem units, e.g., MU 110, which may communicate over analog modulation network 108 without affecting and without being affected by the communication between the CS interfaces.

According to some demonstrative embodiments of the invention, station 106 may receive from LAN 102 DS signals 126 including data to be transmitted to one or more LAN devices, e.g., LAN devices 112 and/or 114, via network 108, e.g., as described in detail below. Station 106 may also provide LAN 102 with US signals 124, e.g., corresponding to the data of US signals 130, e.g., as-described in detail below. Signals 124 and/or 126 may include signals in a format suitable for communicating with LAN 102, e.g., as is known in the art.

According to some demonstrative embodiments of the invention, station 106 may transmit DS frames 128 including the DS circuit switch information using a first transmission method, e.g., Time Division Multiplexing (TDM). Station 106 may transmit DS frames 129, e.g., including DS data of DS signals 126, using a second transmission method, e.g., an IP transmission method, as described in detail below.

According to some demonstrative embodiments of the invention, station 106 may identify DS circuit switch signals 122, e.g., immediately as they arrive. Station 106 may transmit DS frames 128, including the DS circuit switch information, during a plurality of time slots, e.g., in accordance with the TDM transmission method; and DS frames 129 during other time periods, e.g., between the time slots, as described below. As described in detail below, station 106 may prioritize the transmission of frames, e.g., frames 128, that include the DS circuits switch to information, for example, at a higher priority than frames, e.g., frames 129, that include other DS information, e.g., DS data of DS signals 126.

According to some demonstrative embodiments of the invention, station 106 and ST modems 116 and/or 150 may synchronize one or more clocks 177, 179 and 181 (“the slave clocks”) of one or more of interfaces 118, 152, and/or 154, respectively, to a clock 175 (“the master clock”) of CS interface 104, e.g., as described in detail below. The synchronization of the clocks of the local CS interfaces to master clock 175 of interface 104 may enable, for example, the efficient transmission of the CS information between interface 104 and interfaces 118, 152, and/or 154, e.g., using the TDM transmission method. The synchronous transmission of the CS information using the TDM transmission method, according to some demonstrative embodiments of the invention, may enable obtaining a signal at the local CS interfaces which is of substantially constant and accurate bit rate, substantially free of jitter, and/or associated with relatively minimal latency that may be, for example, within common local loop specifications. According to these embodiments, short length (e.g., voice) frames and/or packets may be sent via network 108, e.g., based on the DOCSIS format, while eliminating the relatively heavy Ethernet headers and packet encapsulation overhead related to using the IP transmission method. This simple encapsulation may result, for example, in a very efficient bandwidth transmission, e.g., compared to the traditional VOIP transmission methods, or the traditional TDMoIP methods.

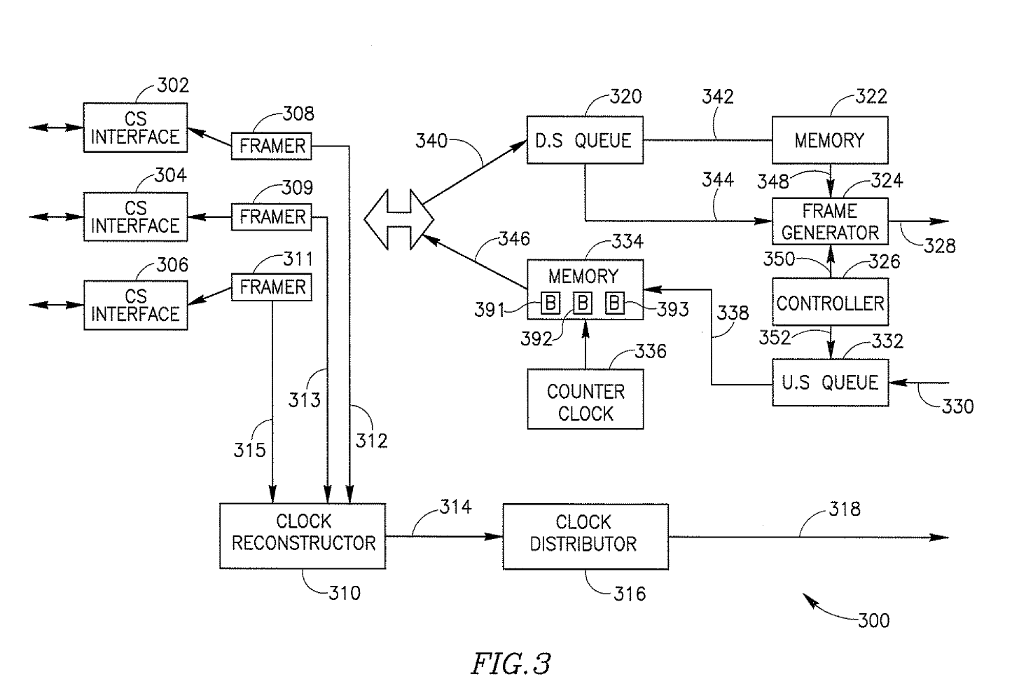

According to some demonstrative embodiments of the invention, station 106 may reconstruct a clock (“the reconstructed master clock”), e.g., based on one or more transmissions from CS interface 104, as described in detail below with reference to FIG. 3. For example, interface 104 may be connected to a CS network 107, e.g., a Public Switched Telephone Network (PSTN). Interface 104 may receive from network 107 clock signals 105 representing a PSTN clock; and may provide station with corresponding clock signals, e.g., as is known in the art. Accordingly, the reconstructed master clock may be reconstructed based on the PSTN clock.

According to some demonstrative embodiments of the invention, station 106 may receive one or more clock signals, for example, from different CS networks or groups, and/or from any other suitable, e.g., external, clock source. Station 106 may select one of the received clock signals to be used as the master clock, e.g., based on any suitable selection scheme.

According to some demonstrative embodiments of the invention, station 106 may transmit one or more analog modulation transmissions over network 108 using the reconstructed master clock. The analog modulation transmissions may include, for example, clock synchronization transmissions, e.g., as are defined by the DOCSIS. One or more of the ST modems, e.g., ST modems 116 and/or 150, may reconstruct a clock (“the reconstructed analog transmission clock”) corresponding to the transmissions received over network 108; and may set the slave clock of the local CS interface, e.g., interfaces 118, 152 and/or 154, based on the reconstructed analog transmission clock. According to some demonstrative embodiments of the invention, station 106 may provide ST modems 116 and/or 150, e.g., over network 108, with an allocation MAP message indicating an upstream bandwidth allocated for upstream TDM transmission, e.g., as is known in the art.

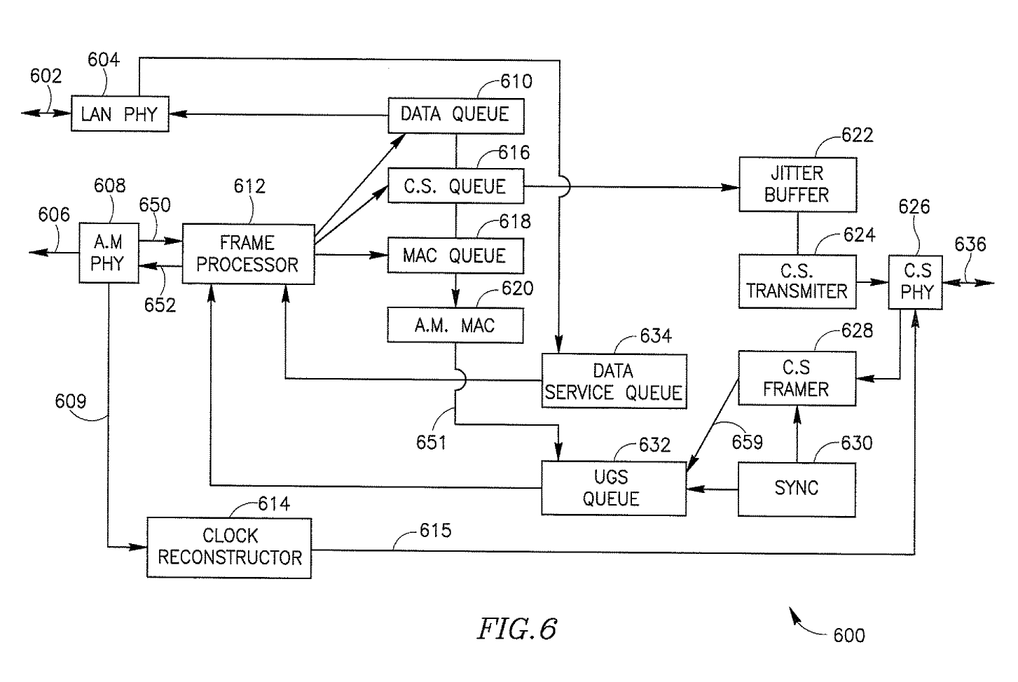

According to some demonstrative embodiments of the invention, ST modems 116 and/or 150 may implement a just-in-time transmission policy, e.g., to transmit US analog modulation frames including US circuit switch information received from the local CS interfaces. For example, the ST modem may include a framer to convert upstream TDM transmissions received from the local CS interface; and a synchronizer to synchronize the operation of the framer to an allocation rate of the transmissions over the AM network, e.g., as described below with reference to FIG. 6. According to some demonstrative embodiments of the invention, the ST modems may time the transmission of US circuit switch information based on the reconstructed analog transmission clocks. For example, ST modem 116 may time the transmission of frames 136 including US circuit switch information received from interface 118, based on the local clock reconstructed by ST modem 118. ST modem 150 may time the transmission of frames including US circuit switch information received from interfaces 152 and/or 154, based on the local clock reconstructed by ST modem 150.

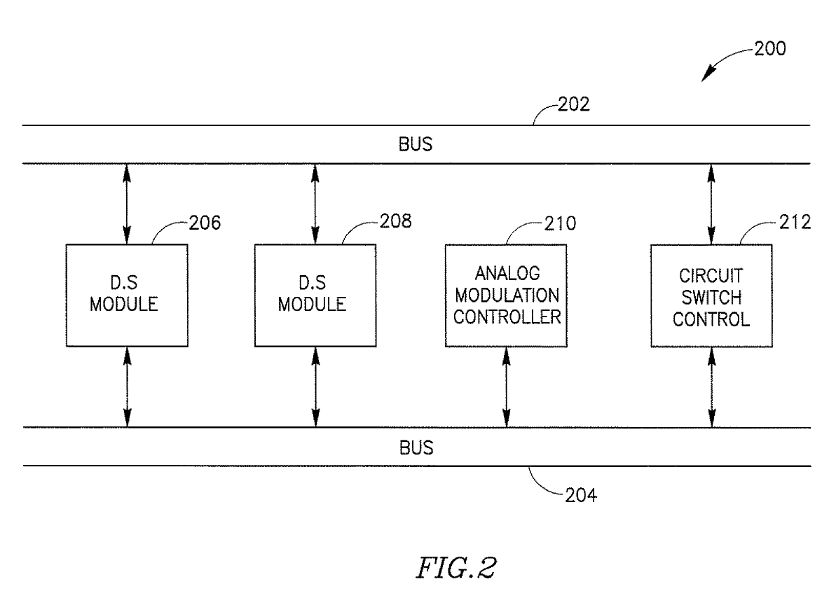

Reference is made to FIG. 2, which schematically illustrates a head-end station 200 in accordance with some demonstrative embodiments of the invention. Although the invention is not limited in this respect, station 200 may perform the functionality of station 106 (FIG. 1).

According to some demonstrative embodiments of the invention, station 200 may include a first bus 202, e.g., to communicate circuit switch information, and a second bus 204, e.g., to communicate analog modulation information, e.g., data in an IP format (“IP data”). Station may also include a downstream module 206, an upstream module 208, and/or a circuit switch control module 212, which may communicate over busses 202 and/or 204, e.g., as described in detail below. Station 210 may also include an analog modulation controller 210 connected to bus 204 to control analog modulation transmissions, e.g., over network 108 (FIG. 1). Analog modulation controller 210 may include, for example, a MAC in compliance with the DOCSIS or the IEEE 802.16 standard, e.g., as is known in the art.

According to some demonstrative embodiments of the invention, CS control module 212 may receive, e.g., over bus 202, DS circuit switch signals, e.g., signals 122 (FIG. 1), and may generate one or more analog modulation frames including DS circuit switch information of signals 122 (“downstream CS frames”). Control module 212 may also identify the frames including DS circuit switch information as CS frames, e.g., by setting a CS indication field of the frames to a predetermined value, as described in detail below with reference to FIGS. 3 and/or 7. Control module 212 may provide the CS frames to DS module 206, e.g., via bus 204. Control module 212 may also reconstruct the master clock, e.g., based on CS transmissions received over bus 204, and provide the reconstructed master clock to DS module 206, US module 208, and/or controller 210, e.g., as described in detail below with reference to FIG. 3. Control module 212 may also receive, e.g., over bus 202, US analog modulation frames including US circuit switch information (“upstream CS frames”), e.g., from US module 208. Control module 212 may also generate US circuit switch signals, e.g., signals 120 (FIG. 1), including the US circuit switch information, e.g., as described below with reference to FIG. 3.

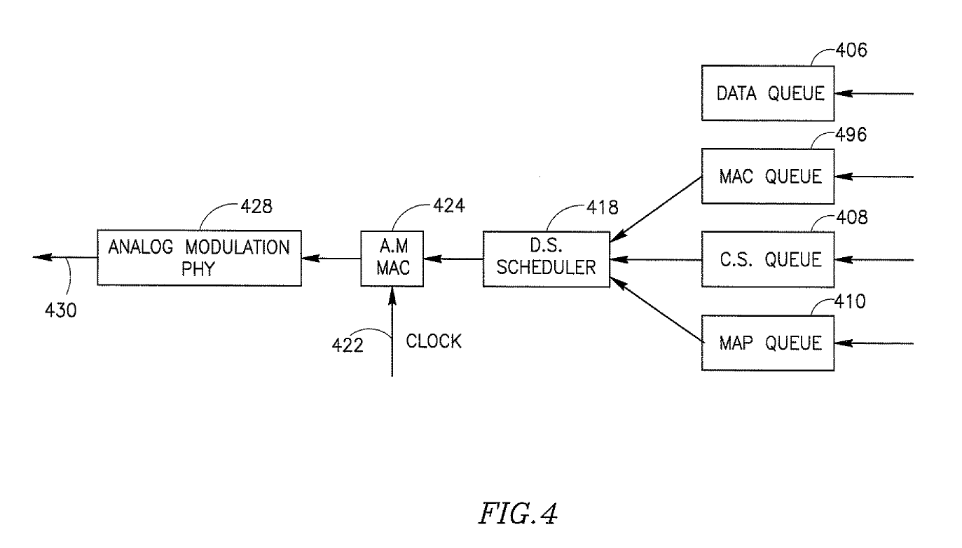

According to some demonstrative embodiments of the invention, DS module 206 may receive the DS analog modulation frames including the DS circuit switch information, e.g., over bus 204; and/or DS frames including DS data of LAN signals 126 (FIG. 1) (“DS data frames”), e.g., over bus 204. According to some demonstrative embodiments of the invention, DS module 206 may prioritize the transmission over network 108 (FIG. 1) of the DS circuit switch information, e.g., at a higher priority than the transmission of the DS data, as described in detail below with reference to FIG. 4. DS module 206 may also time the transmission of the DS circuit switch information according to the master clock, as described below with reference to FIG. 4.

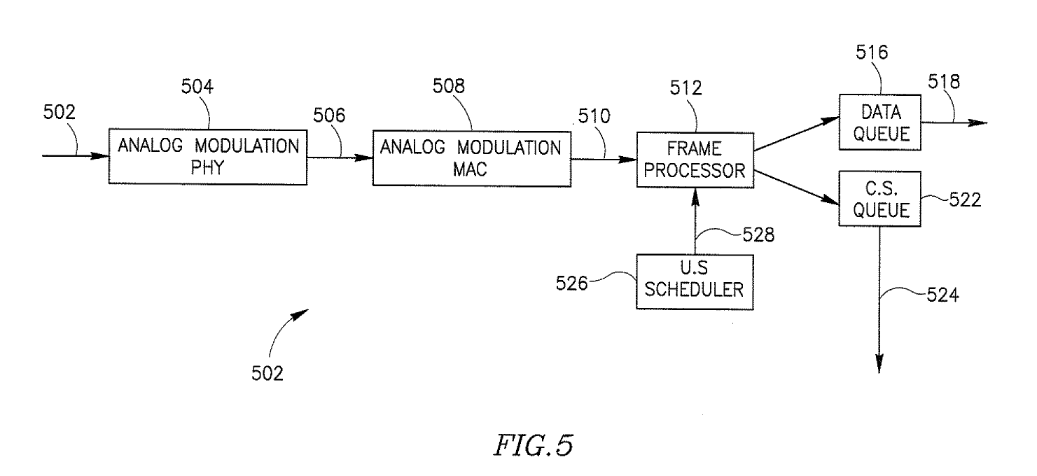

According to some demonstrative embodiments of the invention, US module 208 may receive US analog modulation frames, e.g., over bus 204. For example, US module 208 may receive US analog modulation information of signals 130 (FIG. 1) over bus 204. US module 208 may determine whether the received US frames include CS information, e.g., based on the value of the CS indication field of the frames, as described below with reference to FIG. 5. Module 208 may provide the received US frames to control module 212, e.g., over bus 204, for example, if it is determined that the US frames include US circuit switch information. US module 208 may generate US signals 124 (FIG. 1) including the information of the received frames, for example, if the received frames include IP data, e.g., from device 112 or device 114.

Reference is now made to FIG. 3, which schematically illustrates a CS control module 300 in accordance with some demonstrative embodiments of the invention. Although the invention is not limited in this respect, control module 300 may perform the functionality of control module 212 (FIG. 2).

According to some demonstrative embodiments of the invention, control module 300 may communicate with one or more CS interfaces, e.g., CS interfaces 302, 304, and/or 306.

According to some demonstrative embodiments of the invention, module 300 may also include one or more framers, e.g., framers 308, 309 and/or 311, to convert TDM transmissions to/from CS frames, e.g., as is known in the art. For example, framers 308, 309 and/or 311 may receive from CS interfaces 302, 304 and/or 306, respectively, TDM transmissions including downstream CS information, and generate one or more frames 340, e.g., including the downstream CS information and/or TDM signaling information as is known in the art. Framers 308, 309 and/or 311 may also provide CS interfaces 302, 304 and/or 306, respectively, with TDM transmissions including upstream CS information corresponding to one or more US frames 346. Framers 308, 309 and/or 311 may also generate TDM clock signals 312, 313, and/or 315, respectively, based on the TDM transmissions received from CS interfaces 302, 304, and/or 306, respectively.

According to some demonstrative embodiments of the invention, control module 300 may also include a clock reconstructor 310, which may generate a reconstructed master clock signal 314, e.g., based on clock signals 312, 313, and/or 315. For example, reconstructor 310 may select one of signals 312, 313 and/or 315 based on any suitable clock selection scheme. Reconstructor 310 may also convert the clock frequency of the TDM clock signals into a frequency suitable for transmission over the analog modulation network, e.g., network 108 (FIG. 1). For example, clock signals 312, 313, and/or 315 may include a TDM clock signal corresponding to CS interfaces connected to CS interfaces 302, 204, and/or 206, respectively. Clock signals 312, 313 and/or 315 may include, for example, a 2.48 MHZ clock signal or a 1.56 MHZ clock signal, e.g., corresponding to E1 and a T1 CS interfaces, respectively. Clock signal 314 may include, for example, a clock signal in compliance with the DOCSIS, e.g., a 10.24 MHZ clock signal. Control module 300 may also include a clock distributor 316, e.g., as is known in the art, to distribute clock signal 314 to one or more other modules, e.g., US module 206 (FIG. 2), DS module 208 (FIG. 2), and/or controller 210 (FIG. 2).

According to some demonstrative embodiments of the invention, control module 300 may also include a DS queue 320, e.g., as is known in the art, to queue frames 340. Module 300 may optionally include a memory 322, e.g., a memory matrix, to store TDM data 342 received from queue 320. Memory 322 may perform, for example, any suitable compression algorithm, e.g., an Adaptive Differential Pulse Code Mode compression as is known in the art.

According to some demonstrative embodiments of the invention, control module 300 may also include a frame generator to receive the CS downstream information of frames 340, e.g., from memory 322 via signals 348; to receive TDM timing signals 344 corresponding to frames 340, e.g., from queue 320; and to generate analog modulation frames 328 including the CS downstream information. Generator 324 may generate, for example, analog modulation frames 328 in a form suitable for transmission over network 108 (FIG. 1), e.g., in compliance with the DOCSIS. Although the invention is not limited in this respect, frames 328 may include a reserved-packet format, e.g., as described below with reference to FIG. 7. For example, frames 328 may include a CS indicator to indicate frames 328 include CS information. Frames 328 may be provided to a CS queue of DS module 206 (FIG. 2), e.g., over bus 204 (FIG. 2), as described below with reference to FIG. 4.

According to some demonstrative embodiments of the invention, control module 300 may also include an upstream queue 332 to store US circuit switch frames 330, e.g., received from US module 208 (FIG. 2) over bus 202 (FIG. 2). Queue 332 may include any suitable queue, e.g., as is known in the art. Control module 300 may also include a memory 334, e.g., a memory matrix, to store US circuit switch information TDM and/or signaling of frames 330, e.g., as received via signals 338. Memory 334 may perform, for example, any suitable decompression, e.g., an Adaptive Differential Pulse Code Mode decompression as is known in the art. Memory 334 may include, for example, a plurality of buffers to store US information to be transmitted to the one or more CS interfaces connected to the CS lines. For example, memory 334 may include buffers 391, 392 and/or 393 to store US circuit switch information to be transferred via lines 302, 304, and/or 306, respectively.

It will be appreciate by those of ordinary skill in the art, that a TDM transmission method may require a fixed rate constant transport. Synchronization of the TDM transmission may be affected, e.g., lost, if for example, a frame is missing. According to some demonstrative embodiments of the invention, module 300 may also include a counter clock 336 to control the operation of memory 334, e.g., to transfer frames 346 in compliance with the TDM transmission method. Counter clock 336 may be synchronized, for example, the reconstructed master clock, e.g., of signal 314. For example, counter clock 336 may control memory 334 to transfer frames 346 at substantially fixed time intervals. Counter clock 336 may also control memory to retransfer a previously transferred frame of a buffer, e.g., of buffers 391, 392 and in 393, for example, if there is no new frame in the buffer waiting for transmission. This may enable keeping the TDM synchronization.

According to some demonstrative embodiments of the invention, control module 300 may also include a configuration controller 326 to configure one or more parameters, e.g., by controlling frame generator 324 and/or US queue 332 according, to any suitable criteria.

Reference is now made to FIG. 4, which schematically illustrates a DS module 400 in accordance with some demonstrative embodiments of the invention. Although the invention is not limited in this respect, DS module 400 may perform the functionality of DS module 206 (FIG. 2).

According to some demonstrative embodiments of the invention, DS module 400 may include a plurality of queues, for example, including at least one data queue 406 to queue DS frames including IP data, e.g., of signals 126 (FIG. 1); at least one MAC queue 496 to queue MAC frames, e.g., including control information received from controller 210, as is known in the art; at least one CS queue 408 to queue DS frames including CS information, e.g., of signals 122 (FIG. 1); and/or at least one MAP queue 410 to queue MAP frames, e.g., received from controller 210 (FIG. 2) as known in the art. Queues 406, 408, 496, and/or 410 may include any suitable queue, e.g., a First In First Out (FIFO) queue as is known in the art.

According to some demonstrative embodiments of the invention, DS module 400 may also include a DS scheduler 418 to schedule the transmission of frames from queues 406, 408, 496 and 410. Scheduler 418 may include any suitable prioritized scheduler able to prioritize the transmission of frames from queue 408 at a higher priority than the transmission of frames from queue 406 and/or queue 496. Although the invention is not limited in this respect, scheduler 418 may prioritize the transmission of frames from queue 410 at a higher priority than frames from queue 404.

According to some demonstrative embodiments of the invention, DS module 400 may also include an analog modulation DS MAC 424 and an analog modulation DS physical layer (PHY), e.g., as are known in the art, to control the transmission of DS frames 430 received from scheduler 418 over network 108 (FIG. 1). MAC 424 may be provided with a clock signal 422 including the reconstructed master clock, e.g., received from control module 212. Accordingly, the transmission of the DS frames received from scheduler 418 may be timed according to the clock of signal 422.

Reference is now made to FIG. 5, which schematically illustrates an US module 500 in accordance with some demonstrative embodiments of the invention. Although the invention is not limited in this respect, US module 500 may perform the functionality of US module 208 (FIG. 2).

According to some demonstrative embodiments of the invention, US module 500 may include an US analog modulation PITY 504, and an US analog modulation MAC 508, e.g., as are known in the art, to generate frames 510 corresponding to US analog modulation frames 502, which may be received from network 108 (FIG. 1) over bus 204 (FIG. 2). Frames 502 may include, for example, upstream CS frames including US circuit switch information, e.g., from CS interfaces 118, 152 and/or 154 (FIG. 1). Frames 502 may also include, for example, US data frames including US IP data, e.g., from devices 112, and/or 114 (FIG. 1).

According to some demonstrative embodiments of the invention, US module 500 may also include an US scheduler to schedule the transmission of frames 510. Scheduler 526 may be synchronized, for example, with the reconstructed master clock, e.g., of signal 314 (FIG. 3).

According to some demonstrative embodiments of the invention, US module 500 may also include a frame processor 512. Frame processor 512 may determine whether frame 510 is a CS frame or a data frame. For example, frame processor 512 may determine whether frame 510 is a CS frame based on a destination address field in a header of frame 510, e.g., as described below with reference to FIG. 7. According to some demonstrative embodiments of the invention, frame processor 512 may not be able to process or identify the destination address field of frame 510, for example, if the header is corrupted or damaged. According to some demonstrative embodiments of the invention, scheduler 526 may provide frame processor 512 with an evaluated destination address 528 corresponding to frame 510, e.g., based on previously received frames. For example, scheduler 526 may store the destination address of one or more previously received frames, e.g., corresponding to a received transmission-burst.

According to some demonstrative embodiments of the invention, processor 512 may process frame 510 in compliance with the DOCSIS, e.g., if it is determined that frame 512 includes an US data frame. For example, if it is determined that frame 510 includes an US data frame, then processor 512 may perform an error detection algorithm, e.g., a Cyclic Redundancy Check (CRC), to determine whether frame 510 includes an erroneous frame; may provide frame 510 to a data queue 516, e.g., if it is determined that frame 510 does not include an error; or may discard frame 510, e.g., if it is determined that frame 510 includes an error. According to some demonstrative embodiments of the invention, frame processor 512 may provide frame 510 to a CS queue 522, e.g., without performing an error check, e.g., if it is determined that frame 510 includes CS information. Queue 516 may provide data frames 518 to LAN 102 (FIG. 1), e.g., via bus 204 (FIG. 2). Queue 522 may provide CS frames 524 to control module 300 (FIG. 1), e.g., via bus 202 (FIG. 2). Queues 516 and/or 522 may include any suitable queue, e.g., a FIFO queue.

Reference is now made to FIG. 6, which schematically illustrates a ST modem 600, in is accordance with some demonstrative embodiments of the invention. Although the invention is not limited in this respect, ST modem 600 may perform the functionality of ST modems 116 and/or 150 (FIG. 1).

According to some demonstrative embodiments of the invention, ST modem 600 may include a LAN PHY 604 to communicate over a LAN channel 602, e.g., with LAN device 114 (FIG. 1). LAN PHY 604 may include any suitable PHY, e.g., in accordance with the 802.16 standard. ST modem 600 may also include an analog modulation PHY 608 to communicate over an AM channel 606, e.g., with AM network 108 (FIG. 1). Analog modulation PHY 608 may include any suitable PHY, e.g., in accordance with the DOCSIS. ST modem 600 may also include a CS PHY 626 to communicate over a CS channel 636, e.g., with CS interface 118 (FIG. 1). Circuit switch PHY 626 may include any suitable PHY, e.g., a T1 or an E1 PHY.

According to some demonstrative embodiments of the invention, PHY 608 may generate a clock signal 609 based on downstream AM frequency received over channel 606. Signal 609 may be in a frequency suitable for AM transmissions received from a station, e.g., station 106 (FIG. 1). For example, clock signal 609 may include a clock signal in compliance with the DOCSIS, e.g., a 10.24 MHZ clock signal. Clock signal 609 may correspond to the master clock signal reconstructed by the station, e.g., since the downstream AM transmissions may be generated by the station according to the reconstructed clock, e.g., as described above with reference to FIG. 4. ST modem 600 may also include a clock reconstructor 614 to reconstruct a local clock and generate a clock signal 615 based on clock signal 609. For example, clock signal 609 may include, a clock signal in compliance with the DOCSIS, e.g., a 10.24 MHZ clock signal, and reconstructor 614 may generate clock signal 615, which may include, a 2.48 MHZ clock signal or a 1.56 MHZ clock signal.

According to some demonstrative embodiments of the invention, clock signal 615 may be provided as an input clock to CS PHY 626. Accordingly, downstream transmissions may be performed by PHY 626 in accordance with the reconstructed analog transmission clock of signal 615. Thus, a local clock of a local CS interface connected to PHY 626, e.g., local CS interface 118 (FIG. 1), may be set to the reconstructed analog transmission clock of signal 615, which may be synchronized to the master clock of the master CS interface, e.g., interface 104 (FIG. 1). This may result in the local CS interface clock, e.g., clock 177 of interface 118 (FIG. 1) being synchronized with the master CS interface clock, e.g., clock 175 of CS interface 104 (FIG. 1).

According to some demonstrative embodiments of the invention, modem 600 may also include is a frame processor 612 to process one or more downstream AM frames 650 received from AM

PHY 608.Frame processor may also provide AM PHY 608 with US analog modulation frames 652 to be transmitted over channel 606. Frame processor 612 may determine the type of information, included in frames 650, e.g., CS information, IP data, or MAC information, for example, based on the CS indicator field of the frames. For example, if it is determined that frame 650 includes a DS data frame or a MAC frame, then processor 612 may perform an error detection algorithm, e.g., a CRC, to determine whether frame 650 includes an erroneous frame; may provide frame 650 to a data queue 610 or a MAC queue 618, e.g., if it is determined that frame 650 does not include an error; or may discard frame 650, e.g., if it is determined that frame 650 includes an error. According to some demonstrative embodiments of the invention, frame processor 612 may provide frame 650 to a CS queue 616, e.g., without performing an error check, e.g., if it is determined that frame 650 includes CS information. Queues 610, 616, and/or 618 may include any suitable queues, e.g., FIFO queues. Queue 610 may provide the downstream IP data frames to LAN PHY 604, e.g., as is known in the art. Queue 618 may provide the MAC frames to an analog modulation MAC 620, e.g., a DOCSIS MAC as is known in the art.

According to some demonstrative embodiments of the invention, modem 600 may also include a data service queue 634 to queue upstream IP data frames received from PHY 604, e.g., as is known in the art. Frame processor 612 may process the upstream IP data frames received from queue 634; and generate frames 652 including the upstream IP data, e.g., as is known in the art.

According to some demonstrative embodiments of the invention, modem 600 may also include a jitter buffer 622 and a CS transmitter 624, e.g., as are known in the art, to transmit the CS frames of queue 616 over channel 636, e.g., as CS downstream signals, e.g., signals 142 (FIG. 1).

According to some demonstrative embodiments of the invention, modem 600 may also include a CS framer 628 to receive from CS PHY 626 CS upstream signals, e.g., signals 140 (FIG. 1), from the local CS interface, e.g., interface 118 (FIG. 1), connected to ST modem 600. Framer 628 may include any suitable CS framer, e.g., as is known in the art, to convert the CS upstream signals into upstream CS frames 659 including CS information of the CS upstream signals. ST modem 600 may also include, for example, a constant allocation rate queue, e.g., an Unsolicited Grant Service (UGS) queue 632, to queue frames 659. Queue 632 may also transfer the CS frames to frame processor 612, for example, based on an upstream allocation signal 631 received from MAC 620. The upstream allocation rate may be used to allocate the time periods in which a plurality of modems are allowed to communicate upstream frames to the head end station, e.g., as is known in the art. Frame processor 612 may generate upstream AM frames 652 including the CS upstream information, and a CS indication field having a predetermined value, e.g., as described below with reference to FIG. 7.

According to some demonstrative embodiments of the invention, the conversion of the upstream CS signals may be synchronized to the upstream allocation rate of signal 631. This may enable to reduce a delay between converting the upstream CS signals and transmitting the US frames including the upstream CS information. For example, ST modem 600 may also include a synchronizer 630 to synchronize the operation of framer 628 to the allocation rate implemented by queue 632, e.g., based on the MAP transmissions received from the station, e.g., station 106 (FIG. 1). Synchronizer 630 may be able, for example, to cause framer 628 to start converting the upstream CS signals such that the conversion may be completed by framer 628, at a time within the transmission time period allocated to queue 632. For example, synchronizer 630 may monitor and/or adjust a delay interval between a time in which framer 628 generates frame 659, and a time allocated to queue 632 for transmitting frame 659. Synchronizer 630 may cause framer 628 to start converting the upstream CS signals, such that the delay interval is smaller than or equal to a predetermined delay threshold, e.g., 2 milliseconds.

Reference is now made to FIG. 7, which schematically illustrates an analog modulation frame 700 in accordance with some demonstrative embodiments of the invention. Although the invention is not limited in this respect frame 700 may be generated, for example, by frame processor 612 (FIG. 6), and may include upstream CS information from a local CS interface, e.g., interface 118 (FIG. 1). In another example, frame 700 may be generated by frame generator 324 (FIG. 3), and may include downstream CS information from a master CS interface, e.g., interface 104 (FIG. 1).

According to some demonstrative embodiments of the invention, frame 700 may include a format compatible with network 108 (FIG. 1). For example, frame 700 may include a DOCSIS compatible format.

According to some demonstrative embodiments of the invention, frame 700 may include a MAC header 702, which may be followed by a Protocol Data Unit (PDU) 704. MAC header 702 may include an FC filed 706, which may have a size of, for example, one byte. Field 706 may include an FC-Type code 728, which may have a value representing a reserved packet, is e.g., the binary value 10, if frame 700 includes CS information; an FC_PARAM code 730, which may have a predetermined value, e.g., if frame 700 includes CS information. MAC header 702 may also include a MACPARAM field 708, which may have a size of one byte; a LEN field 710, which may have a value representing a length of a payload field 718 of PDU 704; a BPEH field 712; and/or an HCS filed 714, e.g., as are known in the art. PDU 704 may include, for example, a header field 716, payload field 718, and a CRC field 720. Header field 716 may include a destination address field 798, e.g., as is known in the art. Payload 718 may include a plurality of time slot groups, e.g., groups 722, 724 and 726, including the CS information of a respective time slot group.

A system according to embodiments of the invention may provide better performance, e.g., compared to standard systems including standard CMTS units designed to only accept Ethernet connection as input to the downstream. In such legacy systems insertion of TDM groups to the Ethernet stream is traditionally done via a device called a Gateway, at a high price in latency, in header overhead (and thus reduced transmission efficiency) and in processing burden. Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method of communicating between two or more circuit switch interfaces over an analog modulation communication network, the method comprising:
synchronizing at least one slave clock of at least one respective local circuit switch interface to a master clock of a master circuit switch interface which communicates with said at least one local circuit switch interface over said analog modulation communication network.

2. The method of claim 1, wherein said synchronizing comprises:
generating a reconstructed master clock based one or more circuit switch transmissions received from said master circuit switch interface;
transmitting one or more analog transmissions over said analog modulation network using said reconstructed master clock;
generating a reconstructed analog transmission clock based on said analog transmissions; and
setting said slave clock based on said reconstructed analog transmission clock.

3. The method of claim 2 comprising converting a circuit-switch frequency of the reconstructed master clock into a frequency suitable for said analog transmissions.

4. The method of claim 1 comprising:
receiving from said local interface upstream circuit switch information intended for said master interface; and
timing based on said slave clock a transmission over said analog modulation network of one or more analog modulation frames including said upstream circuit switch information.

5. The method of claim 4 generating one or more of said analog modulation frames having a header including a circuit-switch indicator.

6. The method of claim 1 comprising:
receiving from said master circuit switch interface downstream circuit switch information intended for said local interface;
transmitting over said analog modulation network one or more analog modulation frames including said downstream circuit switch; and
prioritizing the transmission of the frames that include said downstream circuit switch information at a higher priority than frames that include downstream information received from another communication network interface.

7. The method of claim 6, wherein the other communication network comprises an internet protocol data transmission network.

8. The method of claim 1 comprising generating an analog modulation frame to be transmitted over said analog modulation network, said frame including an indicator to indicate whether said frame includes circuit switch information received from one of said master and local circuit switch interfaces.

9. The method of claim 8 comprising:
receiving said frame from said analog modulation network; and
selectively performing an error check of said frame based on a value of said indicator.

10. The method of claim 9 comprising performing said error check only if said indicator indicates said frame does not include said circuit switch information.

11. The method of claim 1, wherein at least one of said master and local interfaces comprises a circuit switch interface selected from the group consisting of an E1 interface, a T1 interface, J1 interface, an OC3 interface, a STM1 interface, and a DS3 interface.

12. The method of claim 1, wherein said analog modulation network comprises a cable communication network.

13. A system of communicating over an analog modulation communication network, the system comprising:
a master circuit switch interface;
at least one local circuit switch interface; and
an interfacing arrangement to communicate between said master interface and said at least one local interface over said analog modulation network, and to synchronize at least one slave clock of said at least one local interface to a master clock of said master interface.

14. The system of claim 13, wherein said interfacing arrangement comprises:
a station connected to said first circuit switch network and to said analog modulation communication network; and
at least one modem connected to said at least one local interface, the modem able to communicate with said station over said analog modulation communication network.

15. The system of claim 14, wherein said station comprises:
a first reconstructor to generate a reconstructed master clock based on one or more circuit switch transmissions received from said master interface; and
a transmitter to transmit one or more analog transmissions over said analog modulation network using the reconstructed master clock,
and wherein said modem comprises:
a receiver to receive said analog transmissions; and
a second reconstructor to generate a reconstructed analog transmission clock based on the received transmissions, and set said slave clock based on the reconstructed analog transmission clock.

16. The system of claim 15, wherein said first reconstructor is able to convert a circuit-switch frequency of the reconstructed master clock into a frequency suitable for said analog transmissions.

17. The system of claim 16, wherein said modem is able to receive from said local interface upstream circuit switch information intended for said master interface; to transmit over said analog modulation network one or more analog modulation frames including said upstream circuit switch information; and to time the transmission of the analog modulation frames including said upstream circuit switch information based on said slave clock.

18. The system of claim 16, wherein said station is able to receive from said master interface downstream circuit switch information intended for said local interface; transmit over said analog modulation network one or more analog modulation frames including said downstream circuit switch information; and prioritize the transmission of frames that include said downstream circuit switch information at a higher priority than frames that include downstream information received from another communication network interface.

19. The system of claim 18, wherein the other communication network comprises an internet protocol data transmission network.

20. The system of claim 14, wherein at least one of said station and modem comprises a frame generator to generate an analog modulation frame to be transmitted over said analog modulation network, said frame including an indicator to indicate whether said frame includes circuit switch information received from one of said master and local interfaces.

21. The system of claim 20, wherein at least one of said station and said modem is able to receive said frame from said analog modulation network; and selectively perform an error check of said frame based on a value of said indicator.

22. The system of claim 13, wherein at least one of said master and local interfaces comprises a circuit switch interface selected from the group consisting of an E1 interface, a T1 interface, a J1 interface, an OC3 interface, a STM1 interface, and a DS3 interface.

23. The system of claim 13, wherein said analog modulation network comprises a cable communication network.
